(19) United States
(12) Patent Application Publication
(10) Pub. No.: US 2019/0005400 A1
(43) Pub. Date: Jan. 3, 2019

(54) A FUZZY EVALUATION AND PREDICTION METHOD FOR RUNNING STATUS OF MECHANICAL EQUIPMENT WITH OCCURRENCE PROBABILITY OF FAILURE MODES

(71) Applicant: SOUTHWEST PETROLEUM UNIVERSITY, Chengdu (CN)

(72) Inventors: Qingyou LIU, Chengdu (CN); Yang TANG, Chengdu (CN); Guorong WANG, Chengdu (CN); Jiajia JING, Chengdu (CN); Yan YANG, Chengdu (CN); Haiyan ZHU, Chengdu (CN); Zhengwei ZOU, Chengdu (CN)

(73) Assignee: SOUTHWEST PETROLEUM UNIVERSITY, Chengdu (CN)

(21) Appl. No.: 15/555,517

(22) PCT Filed: Nov. 30, 2016
(86) PCT No.: PCT/CN2016/108057

§ 371 Date: Sep. 4, 2017

(30) Foreign Application Priority Data
Sep. 20, 2016 (CN) 201610833201.9

(51) Int. Cl. G06N 5/04; G06N 7/00

(52) U.S. Cl. CPC G06N 5/048; G06N 7/005

(57) ABSTRACT

The present invention discloses mechanical equipment running state fuzzy evaluation and prediction methods with occurrence probability of failure modes. The evaluation method includes the following steps: S1, determining a product set and a failure mode set thereof: S2, determining a feature set corresponding to each failure mode; S3, calculating the degradation degree of each feature; S4, calculating the occurrence probability of each failure mode; S5, calculating the membership degree of the occurrence probability of each failure mode; S6, fuzzy comprehensive evaluation is applied to the running state of the part; and S7, fuzzy comprehensive evaluation is applied to the running state of mechanical equipment. The invention further discloses a mechanical equipment running state prediction method.

### CROSS REFERENCE TO RELATED APPLICATIONS

This application is the national phase entry of International Application No. PCT/CN2016/108057, filed on Nov. 30, 2016, which is based upon and claims priority to Chinese Patent Application No. 20160833201.9, filed on Sep. 20, 2016, the entire contents of which are incorporated herein by reference.

### TECHNICAL FIELD

The present invention relates to the technical field of oil and gas equipment or downhole tools, and more particularly, to mechanical equipment running state fuzzy evaluation and prediction method with occurrence probability of failure modes.

### BACKGROUND

One equipment or system consists of multiple subsystems, each having a number of parts. Each part has one or more failure modes which may correspond to one or more features. In the evaluation of the running state of the equipment or system, if the features are extracted for all the failure modes, a large number of feature spaces will be formed, and the features cannot be selected scientifically. In addition, large calculation amount results in great difficulty in evaluation of the running state of mechanical equipment.

In the running process of mechanical equipment of an offshore platform, the state of the mechanical equipment is constantly changing, which is mainly affected by gradual deterioration of external running states and inherent performances. The mechanical equipment of the offshore platform undergoes gradual degradation of performances due to fatigue, corrosion, wear and the like of some parts, and has a fault because they are ultimately beyond the protection thresholds. Meanwhile, in view of common failure modes of the mechanical equipment, most of faults of the mechanical equipment occur gradually. In order to realize the integrity evaluation and the state maintenance strategy optimization of the mechanical equipment of the offshore platform, when the running state of the equipment is in a better state and a general state, it is necessary to predict the development trend of the running state of the equipment, thereby making corresponding running and maintenance suggests in advance according to the current state evaluation result and the state prediction result.

### SUMMARY

The present invention aims to overcome the defects of the prior art, and provide mechanical equipment running state fuzzy evaluation and prediction methods with occurrence probability of failure modes.

According to the method, the number of features in calculation is reduced by using a method of step-by-step solving, so that wrong selection of original features is avoided, the computational amount is reduced, and the rationality and accuracy of state evaluation of mechanical equipment are ensured. The invention further discloses a mechanical equipment running state prediction method.

The aim of the present invention is achieved by means of the following technical solution: a mechanical equipment running state fuzzy evaluation method, comprising:

S1, determining a product set and a failure mode set thereof l parts included in mechanical equipment constitute a part set Z, and all failure modes of l parts constitute a failure mode set F of the parts;

S2, determining a feature set corresponding to each failure mode calculating state features corresponding to m failure modes of the k-th part to constitute a set Yⱼ composed of n state features corresponding to the j-th failure mode of the k-th part, and obtaining a state feature space Y^{m} of m failure modes;

S3, calculating the degradation degree of each feature: calculating the relative degradation degree bₜ(t) of the i-th state feature in the state feature space Y^{m} at a moment t, i.e., and occurrence probability p(Yⱼ) of the state feature, and calculating a state feature full-degradation probability space p^{m} corresponding to m failure modes;

S4, calculating the occurrence probability of each failure mode: calculating a comprehensive occurrence probability P(Fⱼ) of the j-th failure mode in the failure mode set F to obtain an occurrence probability set Pⱼ of m failure modes of the k-th part;

S5, calculating the membership degree of the occurrence probability of each failure mode: substituting the occurrence probabilities of m failure modes in the failure mode occurrence probability set Pⱼ into a part running state membership degree function respectively to calculate a membership degree matrix Rₖ of m failure modes included in the k-th part;

S6, fuzzy comprehensive evaluation is applied to the running state of the part: establishing a weight matrix Bₖ of m failure modes included in the k-th part, calculating a membership degree vector Dₖ, attached to a running state, of an i-th product, determining a state under which the k-th part is located according to the maximum membership principle, and generating a running state membership degree space Cᵢ of l parts included in the mechanical equipment;

S7, fuzzy comprehensive evaluation is applied to the running state of mechanical equipment: defining a weight vector of 1 parts included in the mechanical equipment as Wᵢ, obtaining a state comment S of the mechanical equipment in combination with the running state membership degree space C₁ of l parts included in the mechanical equipment, and obtaining a state under which the mechanical equipment is located according to the maximum membership principle.

The step S1 comprises:

S11, dividing the mechanical equipment into l parts which constitute a part set Z={z₁, z₂,L, zₗ}; and

S12, carrying out fault risk identification on each part to obtain all failure modes of each part, thereby constituting a failure mode set F={F₁, F₂, L, Fₘ} of each part.

In the step S12, all the parts are subject to risk identification adopting an FMECA method to calculate risk equivalence values and a sequence of all the failure modes of the parts, and choosing key failure modes of the parts to constitute a failure mode set F={F₁, F₂, L, Fₘ} of the parts.

In the step S11, the mechanical equipment is divided into a plurality of parts, the importance degree of each part is calculated and l parts of which the importance degrees are greater than a threshold are chosen, the l parts constituting a part set Z={z₁, z₂,L, zₗ}.

The method of calculating the importance degree of the part comprises:

S111, establishing importance degree evaluation indexes of equipment;

S112, establishing a scoring standard of each evaluation index;

S113, determining by a plurality of evaluators, an initial weight value and an optimal sequence relationship of each evaluation index by adopting an analytic hierarchy process to obtain multiple initial weight values and optimal sequence relationship of each evaluation index;

S114, processing the multiple weight values of each evaluation index by adopting a fuzzy Borda sequence value method to obtain a Borda value of each evaluation index;

S115, generating a final weight value and an optimal sequence relationship of each evaluation index according to the Borda value of each evaluation index; and

S116, calculating the importance degree of the equipment according to the final weight value and the optimal sequence relationship of each evaluation index.

In the step S3, a computational formula of the fault occurrence probability p(Yⱼ) is as follows:

p(Yⱼ)=bᵢ(t)=F[Yᵢ(t), Yᵢ₀, Yᵢ₀*]

in the formula, j=1,2,L, n; F[●] is a relative degradation degree function of the i-th state feature; Yᵢ(t) is a state value of the i-th state feature at a moment t; Yᵢ₀ is a normal value of the i-th state feature; Yᵢ* is a threshold of fault or shutdown caused by the i-th state feature.

In the step S4, a computational formula of the comprehensive occurrence probability P(Fⱼ) of the j-th failure mode in the failure mode feature set F is as follows:

$$P ( {F}_{j} ) = [ p ( {Y}_{1} ) , p ( {Y}_{2} ) , L , p ( {Y}_{n} ) ] [ \begin{matrix}{ω}_{1} \\ {ω}_{2} \\ L \\ {ω}_{n}\end{matrix} ]$$

in the formula: n is the number of state features corresponding to the j-th failure mode in the failure mode set F; ω=[ω₁, ω₂,L,ωₙ]^{r} is the weight vector corresponding to the state feature set, wherein ωᵢ∈[0,1] and satisfies

$${\sum }_{i = 1}^{n} {ω}_{i} = 1.$$

In the step S5, the running state of the part is divided into four running states, namely, a good state, a better state, a general state an a quasi-fault state, the four running states being considered as four fuzzy subsets S={s₁,s₂,s₃,s₄} by applying a fuzzy set theory;

with the fuzzy subset s₁=good state, the part is in a good state when the value of the failure mode occurrence probability pᵢ is within [0, 0.2], is in a good state or better state when it is within [0.2, 0.4], and is out of a good state when it is within [0.4, 1], and then a computational formula for a running state membership degree function of the part is as follows:

$${r}_{{s}_{1}} ( {P}_{i} ) = \{ \begin{matrix}1 , {P}_{i} < 0.2 \\ \frac{1}{2} - \frac{1}{2} sin [ \frac{π}{0.2} ( {P}_{i} - 0.3 ) ] , 0.2 < {P}_{i} \leq 0.4 \\ 0 , {P}_{i} > 0.4\end{matrix}$$

with the fuzzy subset s₂=better state, the part is out of a better state when the value of the failure mode occurrence probability pᵢ is within [0, 0.2], is in a good state or better state when it is within [0.2, 0.4], is in a better state or general state when it is within [0.4, 0.7] and is out of a better state when it is within [0.7, 1], and then a computational formula of the running state membership degree function of the part is as follows:

$${r}_{{s}_{1}} ( {P}_{i} ) = \{ \begin{matrix}0 , {P}_{i} < 0.2 \\ \frac{1}{2} + \frac{1}{2} sin [ \frac{π}{0.2} ( {P}_{i} - 0.3 ) ] , 0.2 < {P}_{i} \leq 0.4 \\ \frac{1}{2} - \frac{1}{2} sin [ \frac{π}{0.3} ( {P}_{i} - 0.55 ) ] , 0.4 < {P}_{i} \leq 0.7 \\ 0 , {P}_{i} > 0.7\end{matrix} ;$$

with the fuzzy subset s₃=general state, the part is out of a general state when the value of the failure mode occurrence probability pᵢ is within [0, 0.4], is in a good state or better state when it is within [0.4, 0.7], is in a quasi-fault state or general state when it is within [0.7, 0.9] and is out of a general state when it is within [0.9, 1], and then a computational formula of the running state membership degree function of the part is as follows:

$${r}_{{s}_{1}} ( {P}_{i} ) = \{ \begin{matrix}0 , {P}_{i} < 0.4 \\ \frac{1}{2} + \frac{1}{2} sin [ \frac{π}{0.3} ( {P}_{i} - 0.55 ) ] , 0.4 < {P}_{i} \leq 0.7 \\ \frac{1}{2} - \frac{1}{2} sin [ \frac{π}{0.2} ( {P}_{i} - 0.8 ) ] , 0.7 < {P}_{i} \leq 0.9 \\ 0 , {P}_{i} > 0.9\end{matrix} ;$$

with respect to the fuzzy subset s₄=quasi-fault state, the part is out of a quasi-fault state when the value of the failure mode occurrence probability pᵢ is within [0, 0.7], is in a quasi-fault state or general state when it is within [0.7, 0.9], and is in a quasi-fault state when it is within [0.9, 1], and then the computational formula of the running state membership degree function of the part is as follows:

$${r}_{{s}_{1}} ( {P}_{i} ) = \{ \begin{matrix}0 , {P}_{i} < 0.7 \\ \frac{1}{2} + \frac{1}{2} sin [ \frac{π}{0.2} ( {P}_{i} - 0.8 ) ] , 0.7 < {P}_{i} \leq 0.9 \\ 1 , {P}_{i} > 0.9\end{matrix} .$$

A mechanical equipment running state fuzzy prediction method with occurrence probability of failure modes, comprises the following steps:

SS1, determining failure modes of equipment and corresponding state features thereof: acquiring failure modes of equipment included in mechanical equipment, and calculating a state feature corresponding to each failure mode;

SS2, determining time sequence sample data of the state features: collecting a plurality of time sequence values of each state feature at regular times, processing the time sequence values of each state feature, and calculating a relative degradation degree of the state feature within a certain time;

SS3, determining a training sample set: establishing the training sample set according to the relative degradation degree of each state feature;

SS4, learning a training LS-SVR prediction model: with LS-SVM as a predictor, establishing a prediction model of the state feature using a LS-SVR method;

SS5, verifying th effectiveness of the LS-SVR prediction model: verifying whether the LS-SVR prediction model satisfies requirements, and executing SS6 if the LS-SVR prediction model satisfies requirements;

SS6, predicting the state feature: calculating a prediction value of each state feature according to the LS-SVR prediction model; and

SS7, evaluating the running state of the mechanical equipment according to the prediction value of each state feature.

The prediction method further comprises:

SS8, estimating the remaining life of the mechanical equipment: finishing prediction of one step on the basis of the prediction value of the state feature of the j′-th step, and judging whether the prediction value reaches a state feature threshold thereof; if the value does not reach the state feature threshold thereof, carrying out state feature prediction of j′+l-th step, and then judging whether the value reaches a set state feature threshold again, till the prediction value of j′+k′-th step reaches the state feature threshold thereof, wherein the estimated value of the remaining value of the mechanical equipment is (j′+k′)t, in which t is a time interval of two adjacent time sequence values of each state feature.

The present invention has the following beneficial effects:

(1) The number of features in calculation is reduced by using a method of step-by-step solving from feature, failure mode, part, subsystem, equipment or system, so that wrong selection of original features is avoided, and the rationality and accuracy of state evaluation are effectively ensured;

(2) Based on the characteristic that the state features of equipment have time sequences, the running state prediction feasibility of the mechanical equipment is analyzed, and a prediction thought is proposed; in view of the characteristics such as many types and complicated change forms of state features, an LS-SVR-based mechanical equipment state time sequence prediction method is proposed; by means of the method, the features are grouped based on the failure modes according to the relevance between the failure modes and the features, and a prediction mode is established for each group, thereby effectively avoiding the problems of redundant features and great computational amount.

### BRIEF DESCRIPTION OF THE DRAWINGS

FIG. 1 is a flowchart of A Framework for Fuzzy evaluation and prediction method for running status of mechanical equipment with occurrence probability of failure modes;

FIG. 2 is a flowchart of the importance degree evaluation of mechanical equipment of an offshore platform;

FIG. 3 is a flowchart of determination of an initial weight value of each evaluation index by adopting an analytic hierarchy process;

FIG. 4 is a flowchart of one embodiment in which the importance degree of equipment is calculated;

FIG. 5 is a flowchart of another embodiment in which the importance degree of equipment is calculated;

FIG. 6 is a flowchart of comprehensive evaluation of the occurrence probability of failure modes;

FIG. 7 is a flowchart of a mechanical equipment running state fuzzy prediction method with occurrence probability of failure modes.

### DETAILED DESCRIPTION OF THE INVENTION

The present invention will now be described in detail with reference to the accompanying drawings, but the scope of the present invention is not limited to the followings.

### Embodiment 1

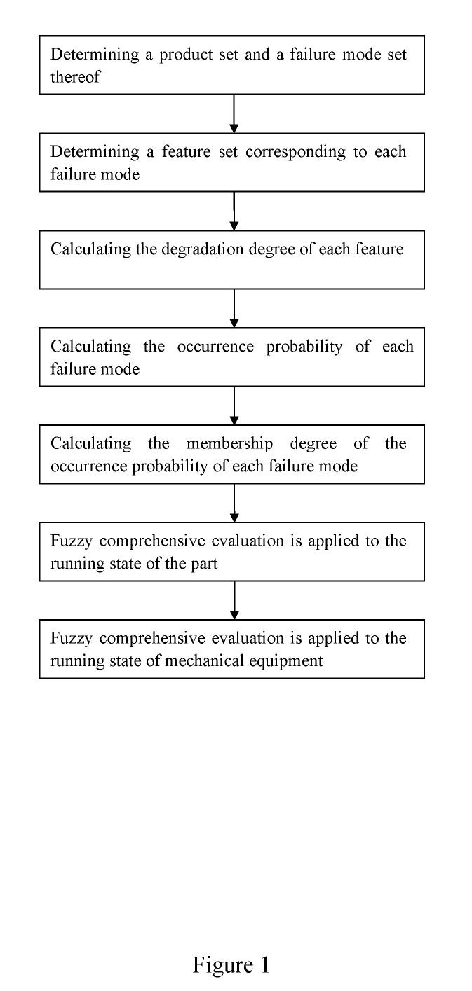

As illustrated in FIG. 1, A Framework for Fuzzy evaluation and prediction method for running status of mechanical equipment with occurrence probability of failure modes comprises the following steps S1-S7.

In step S1, a product set and a failure mode set therof are determined: dividing mechanical equipment into l parts, the l parts constituting a part set Z={z₁,z₂,L,zₗ}; carrying out fault risk identification on each part, and acquiring all the failure modes of each part to constitute a failure mode set F={F₁,F₂,L, Fₘ} of each part.

Preferably, each part is subject to fault risk identification by adopting a FMECA method to calculate

risk equivalence values and a sequence of all the failure modes of each part, and key failure modes of each part are chosen to constitute a failure mode set F={F₁,F₂,L, Fₘ} of each part.

Preferably, the mechanical equipment is divided into a plurality of parts, the importance degree of each part is calculated, and l parts of which the importance degrees are greater than a threshold are chosen, the l parts constituting a part set Z={z₁, z₂,L, zₗ}.

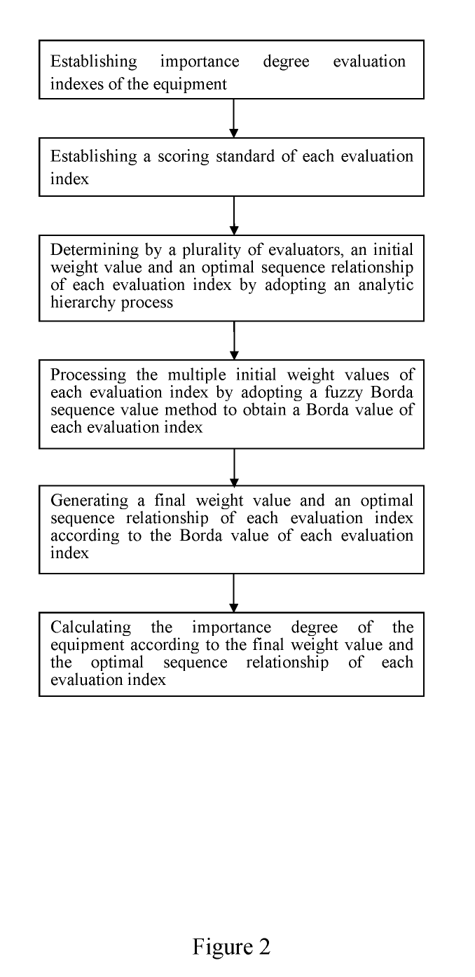

As illustrated in FIG. 2, a method of calculating the importance degree of the part comprises the following steps S111-S116:

S111: establishing evaluation indexes of the importance degrees of equipment;

S112: establishing a scoring standard of each evaluation index; and

S113: determining by a plurality of evaluators, an initial weight value and an optimal sequence relationship of each evaluation index by adopting an analytic hierarchy process to obtain multiple initial weight values and optimal sequence relationships of each evaluation index.

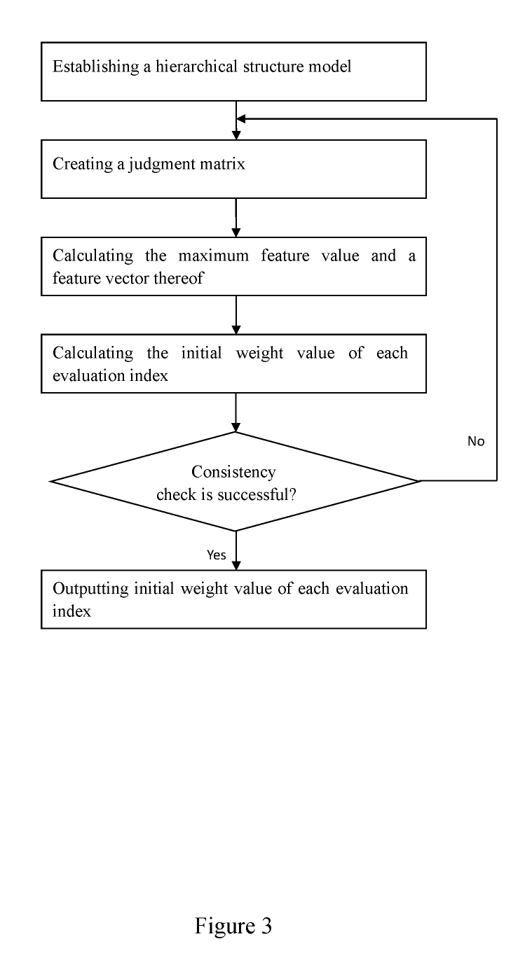

As illustrated in FIG. 3, determining, by the evaluators, initial weight value and an optimal sequence relationship of each evaluation index by adopting an analytic hierarchy process comprises the following steps:

S1131, establishing a hierarchical structure model: establishing a hierarchical structure model of importance degrees of equipment according to the evaluation indexes of the importance degrees of the equipment;

S1132, creating a judgment matrix: comparing the evaluation indexes pairwise by the evaluator to create a judgment matrix D:

$$D = [ \begin{matrix}{u}_{11} & {u}_{12} & L & {u}_{1 n} \\ {u}_{21} & {u}_{22} & L & {u}_{2 n} \\ L & L & L & L \\ {u}_{n 1} & {u}_{n 2} & L & {u}_{nn}\end{matrix} ]$$

in which, uᵢⱼ represents the relative importance degree of the i-th evaluation index to the j-th evaluation index; uⱼᵢ represents the relative importance degree of the j-th evaluation index to the i-th evaluation index; the value of uⱼᵢ is a reciprocal of uᵢⱼ;

S1133, calculating the maximum feature value and a feature vector thereof: calculating the maximum feature value λₘₐₓ of the judgment matrix D, and calculating the feature vector W corresponding to the maximum feature value λₘₐₓ according to the following formula:

$$\{ \begin{matrix}( {u}_{11} - λ ) {ω}_{1} + {u}_{12} {ω}_{2} + L + {u}_{1 n} {ω}_{n} = 0 \\ {u}_{11} {ω}_{1} + ( {u}_{12} - λ ) {ω}_{2} + L + {u}_{1 n} {ω}_{n} = 0 \\ L L L \\ {u}_{11} {ω}_{1} + {u}_{12} {ω}_{2} + L + ( {u}_{1 n} - λ ) {ω}_{n} = 0\end{matrix} \\ W = ( {ω}_{1} + {ω}_{2} + L + {ω}_{n} )$$

S1134, normalizing the feature vectors W to obtain an initial weight value of each evaluation index, and generating an optimal sequence relationship of the evaluation indexes according to the initial weight value of each evaluation index;

S1135, carrying out consistency check: carrying out consistency check on the judgment index D according to the following formula: if the consistence check is successful, outputting the initial weight value of each evaluation index and the optimal sequence relationship; or executing the step S1132:

CR=CI/RI, CI=(λₘₐₓ−n)/(n−1)

in which, CR represents a random consistency rate of the judgment matrix D; CI represents a general consistency index of the judgment matrix D; RI represents an average random consistency index of the judgment matrix D.

S114, processing the multiple weight values of each evaluation index by adopting a fuzzy Borda sequence value method to obtain a Borda value of each evaluation index.

The step S114 comprises the following steps S1141-S1144:

S1141, determining the membership degree μₘₙ: calculating an optimal membership degree μₙₘ to which the weight value Dₙ of each evaluation index belongs, in the initial weight values and the optimal sequence relationship of equipment determined by m-th evaluator, according to the following formula:

$${μ}_{mn} = {B}_{m} ( {D}_{n} ) / {max}_{n} \{ {B}_{m} ( {D}_{1} ) , {B}_{m} ( {D}_{2} ) , L , {B}_{m} ( {D}_{n} ) \}$$

in which Bₘ(Dₙ) is a utility value of the weight value Dₙ of the evaluation index in the initial weight value and optimal sequence relationship of the equipment determined by the m-th evaluator;

S1142, calculating a fuzzy frequency number fₖₙ and the fuzzy frequency Wₖₙ:

$${f}_{kn} = {\sum }_{m = 1}^{M} {δ}_{n}^{k} ( {D}_{n} ) {μ}_{mn}$$

$${W}_{kn} = {f}_{kn} / {R}_{n} , {R}_{n} = {\sum }_{k} {f}_{kn}$$

In which, Sₙ^{k}(Dₙ)=1, if Dₙ ranks in a k-th place in the optimal sequence relationship determined by the m-th evaluator; and

Sₙ^{k}(Dₙ)=0, if Dn does not rank in a k-th place in the optimal sequence relationship determined by the m-th evaluator;

S1143, calculating an optimal sequence relationship score Qₖ: calculating the score of the weight value Dₙ of each evaluation index ranking in the k-th place in the optimal sequence relationship:

$${Q}_{k} = \frac{1}{2} ( N - k ) ( N - k = 1 )$$

S1144, calculating a Borda value: calculating a Borda value FB(Dₙ) of each evaluation index according to the following formula:

$$FB ( {D}_{n} ) = {\sum }_{k} {W}_{kp} {Q}_{k} .$$

S115: generating a final weight value and an optimal sequence relationship of each evaluation index according to the Borda value of each evaluation index.

S116, calculating the importance degree of the equipment according to the final weight value and the optimal sequence relationship of each evaluation index.

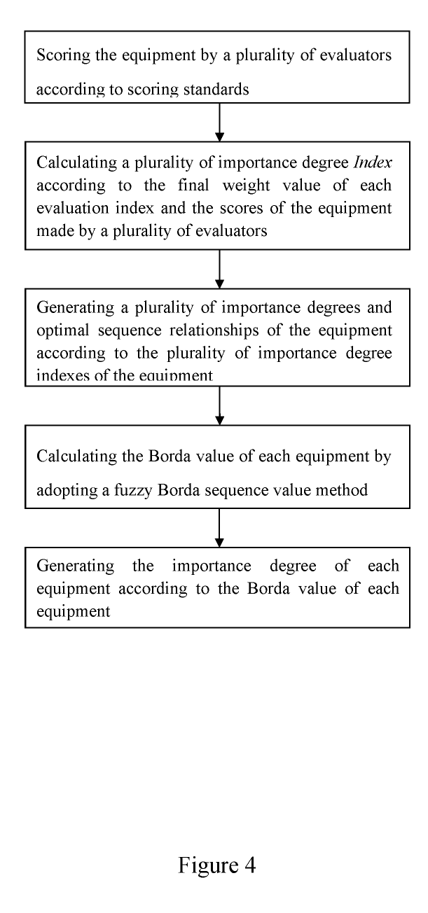

As illustrated in FIG. 4, the step S116 comprises the following steps S1161-S1165:

S1161, scoring the equipment by a plurality of evaluators according to scoring standards.

S1162, calculating a plurality of importance degree Index according to the final weight value of each evaluation index and the scores of the equipment made by a plurality of evaluators;

S1163, generating a plurality of importance degrees and optimal sequence relationships of the equipment according to the plurality of importance degree Index of the equipment;

S1164, calculating the Borda value of each equipment by adopting a fuzzy Borda sequence value method; and

S1165, generating the importance degree of each equipment according to the Borda value of each equipment.

The computational formula of the importance degree Index of the equipment is

$$Index = {\sum }_{i = 1}^{n} {v}_{i} {w}_{i} ,$$

in which, n represents a number of evaluation indexes; vᵢ represents the score of the equipment made by the evaluator according to the i-th evaluation index: wi represents the final weight value of the i-th evaluation index.

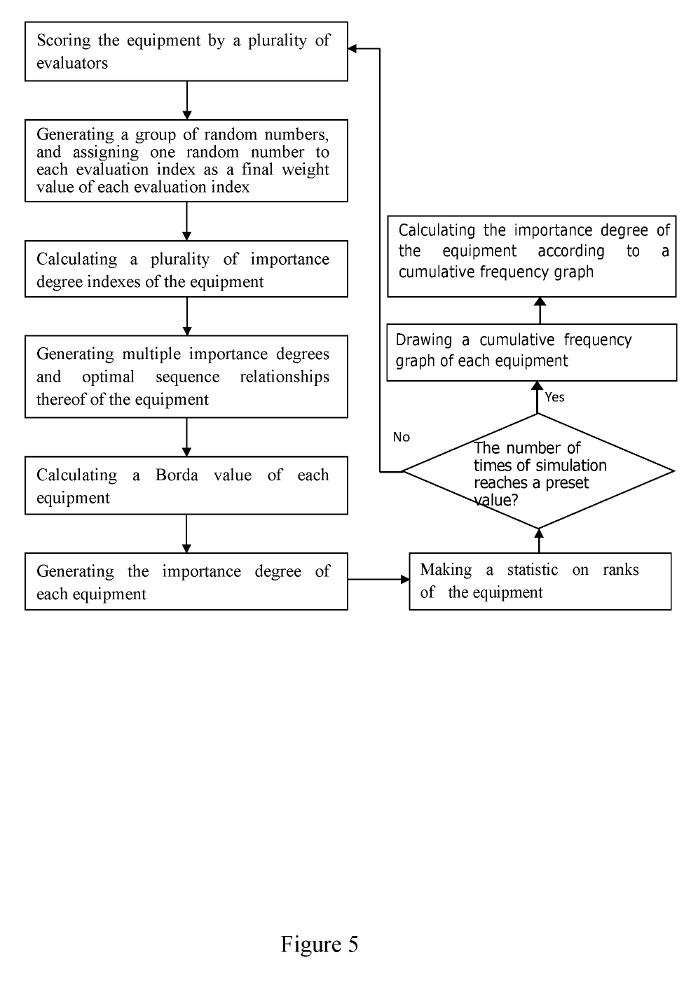

As illustrated in FIG. 5, the step S1161 further comprises the following steps: updating the final weight value of the evaluation index; generating a group of random numbers, assigning one random number to each evaluation index according to a preset rule, and updating the final weight value of each evaluation index into the corresponding random number thereof.

Updating the final weight value of the evaluation index comprises the following steps: generation a group of random numbers by a uniform random generator distributed within (0,1), the number of the random numbers being identical with that of the evaluation indexes; assigning the random numbers among the group of random numbers to the evaluation indexes having the priorities from high to low, according to a sequence from big to small; and updating the final weight value of each evaluation index into the corresponding random number thereof.

The step S116, after 1165, further comprises the following steps S1166-S1169:

S1166, making a statistic on the ranks of the equipment according to the importance degrees to acquire a sequence number to which each equipment belongs;

S1167, judging whether the number of times of simulation reaches a preset value: if the number of times of simulation reaches the present value, executing step S1168; or executing step S1161;

S1168, drawing a cumulative frequency graph of each equipment according to the cumulative frequency of the sequence number of each equipment; and

S1169, calculating the importance degree of each equipment according to the cumulative frequency graph of the equipment.

In the step S1169, an importance degree calculation method comprises: calculating the importance degree of each equipment according to a cumulative rate of a cumulative curve of each equipment in the cumulative frequency graph; or calculating the importance degree of each equipment according to an area defined by the right side of the cumulative curve of each equipment in the cumulative frequency graph.

S2, determining a feature set corresponding to each failure mode: carrying out fault risk identification on the parts to obtain failure modes, fault causes and fault effects; calculating state features respectively corresponding to m failure modes of the k-th (k=1,2,L,l) in a part set Z={z₁, z₂, L, zₗ} to constitute a set Yⱼ={Yⱼ₁(t),Yⱼ₂(t),L,Yⱼₙ(t)} composed of n state features corresponding to the j-th (j=1,2,L,m) failure modes of the k-th part, thereby obtaining a state feature space Y^{m} of m failure modes.

S3, calculating the degradation degree of each feature: calculating the relative degradation degree bᵢ(t) of the i-th (i=1,2,L,n) state feature in the state feature space Y^{m} at a moment t, i.e., an occurrence probability p(Yⱼ) of the state feature, and calculating a state feature full-degradation probability space p^{m} corresponding to m failure modes.

The feature state is defined in a full-degradation state when the relative degradation degree thereof reaches “1”, according to the change law and characteristics of the state feature. The relative degradation degree bᵢ(t) of the state feature at a moment t is used as the occurrence probability p(Yᵢ) of the state feature to full degradation, that is, the relative degradation function of the state feature is a state feature full-degradation probability calculation function. Meanwhile, the greater the relative degradation degree is, the greater the occurrence probability of full degradation of the feature. Therefore, in the step S3, the computational formula of the fault occurrence probability p(Yⱼ) is as follows:

p(Yⱼ)=bᵢ(t)=F[Yᵢ(t),Yᵢ₀,Yᵢ*]

in which, j=1,2,L,n; F[●] is a relative degradation degree function of the i-th state feature; Yᵢ(t) is a state value of the i-th state feature at a moment t; Yᵢ₀ is a normal value of the i-th state feature; Yᵢ* is a threshold of fault or shutdown caused by the i-th state feature.

S4, calculating the occurrence probability of each failure mode: calculating a comprehensive occurrence probability P(Fⱼ) of the j-th failure mode in the failure mode set F to obtain an occurrence probability set Pⱼ={P(F₁), P(F₂),L,P(Fₘ)} of m failure modes of the k-th part.

In the step S4, a computational formula of the comprehensive occurrence probability P(Fⱼ) of the j-th failure mode in the failure mode feature F is as follows:

$$P ( {F}_{j} ) = [ p ( {Y}_{1} ) , p ( {Y}_{2} ) , L , p ( {Y}_{n} ) ] [ \begin{matrix}{ω}_{1} \\ {ω}_{2} \\ L \\ {ω}_{n}\end{matrix} ]$$

in which, n is the number of state features corresponding to the j-th failure mode in the failure mode set F: ω=[ω₁,ω₂,L ωₙ]^{t} is a weight vector corresponding to the state feature mode set, in which ωᵢ∈[0,1] and satisfies

$${\sum }_{i = 1}^{n} {ω}_{i} = 1.$$

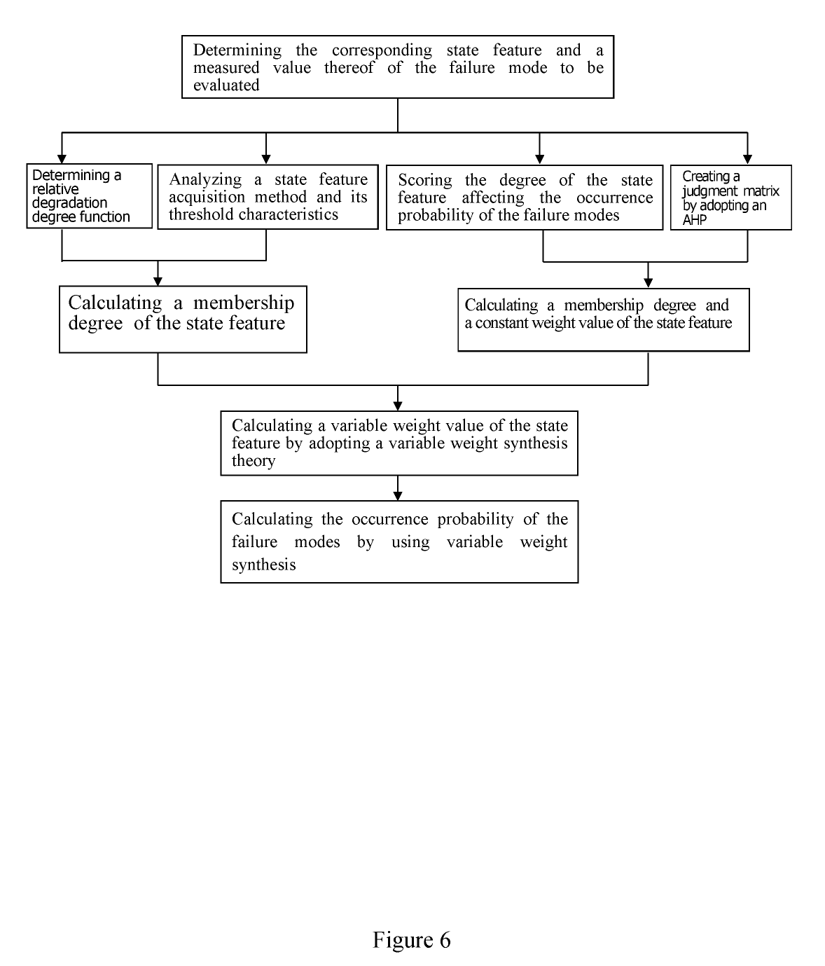

In this embodiment a failure mode occurrence probability comprehensive evaluation method based on a variable synthesis theory is used to calculate the comprehensive occurrence probability P(Fⱼ), wherein the specific steps are illustrated in FIG. 6; first determining the state feature and its measured value corresponding to the failure mode to be evaluated; then analyzing a state feature acquisition method and its threshold characteristics; determining a relative degradation degree function; scoring the degree of the state feature affecting the occurrence probability of the failure modes; creating a judgment matrix by adopting an AHP (Analytic Hierarchy Process); then calculating a membership degree and a constant weight value of the state feature; calculating a variable weight value of the state feature by adopting a variable weight synthesis theory; and finally calculating the occurrence probability of the failure modes by using variable weight synthesis.

S5, calculating the membership degree of the occurrence probability of each failure mode: substituting the occurrence probabilities of m failure modes in the failure mode occurrence probability set Pⱼ into a part running state membership degree function respectively to calculate a membership degree matrix Rₖ of m failure mode included in the k-th part

$${R}_{k} = [ \begin{matrix}{r}_{{s}_{1}} ( {R}_{k 1} ) & {r}_{s 2} ( {R}_{k 1} ) & {r}_{s 3} ( {R}_{k 1} ) & {r}_{s 4} ( {R}_{k 1} ) \\ {r}_{{s}_{1}} ( {R}_{k 2} ) & {r}_{s 2} ( {R}_{k 2} ) & {r}_{s 3} ( {R}_{k 2} ) & {r}_{s 4} ( {R}_{k 2} ) \\ L & L & L & L \\ {r}_{{s}_{1}} ( {R}_{km} ) & {r}_{s 2} ( {R}_{km} ) & {r}_{s 3} ( {R}_{km} ) & {r}_{s 4} ( {R}_{km} )\end{matrix} ] .$$

In the step S5, the running state of the part is divided into four running states, namely, a good state, a better state, a general state and a quasi-fault state, and the four running states being considered as S={s₁, s₂,s₃,s₄} by applying a fuzzy set theory, as illustrated in Table 1

TABLE 1
State Division of mechanical equipment of Offshore Platform

| State Description | Running | State |
|---|---|---|
| The mechanical equipment can achieve the specific | good state | ^{S}1 |
| functions well and can be continuously used for a | | |
| long time | | |
| Abnormal sign occurs in the system, the mechanical | better state | ^{S}2 |
| equipment can operate, but performances degrade | | |
| More serious abnormal sign occurs in the system, the | general | ^{S}3 |
| mechanical equipment can operate, but performances | state | |
| greatly degrade | | |
| Serious sign occurs in the system, the mechanical | quasi-fault | ^{S}4 |
| equipment can hardly achieve the specific | state | |
| performances thereof | | |

with the fuzzy subset s₁=good state, the mechanical equipment is in a good state when the value of the failure mode occurrence probability pᵢ is within [0, 0.2], is in a good state or better state when it is within [0.2, 0.4], and is out of a good state when it is within [0.4, 1]. Therefore, according to the value assignment characteristic and the distribution type of the fault occurrence probability when the equipment is in a good state, the membership degree function is determined as down half mountain distribution, and then the computational formula of the part running state membership degree function is as follows:

$${r}_{{s}_{1}} ( {P}_{i} ) = \{ \begin{matrix}1 , {P}_{i} < 0.2 \\ \frac{1}{2} - \frac{1}{2} sin [ \frac{π}{0.2} ( {P}_{i} - 0.3 ) ] , 0.2 < {P}_{i} \leq 0.4 \\ 0 , {P}_{i} > 0.4\end{matrix}$$

with the fuzzy subset s₂=better state, the mechanical equipment is out of a better state when the value of the failure mode occurrence probability pᵢ is within [0, 0.2], is in a good state or better state when it is within [0.2, 0.4], is in a better state when it is within [0.4, 0.7] and is out of a better state when it is within [0.7, 1]. Therefore, according to the value assignment characteristic and the distribution type of the fault occurrence probability when the equipment is in a better state, the membership degree function is determined as centrally symmetric half mountain distribution, and then the computational formula of the part running state membership degree function is as follows:

$${r}_{{s}_{1}} ( {P}_{i} ) = \{ \begin{matrix}0 , {P}_{i} < 0.2 \\ \frac{1}{2} + \frac{1}{2} sin [ \frac{π}{0.2} ( {P}_{i} - 0.3 ) ] , 0.2 < {P}_{i} \leq 0.4 \\ \frac{1}{2} - \frac{1}{2} sin [ \frac{π}{0.3} ( {P}_{i} - 0.55 ) ] , 0.4 < {P}_{i} \leq 0.7 \\ 0 , {P}_{i} > 0.7\end{matrix}$$

with the fuzzy subset s₃=general state, the mechanical equipment is out of a general state when the value of the failure mode occurrence probability pᵢ is within [0, 0.4], is in a good state or better state when it is within [0.4, 0.7], is in a quasi-fault state or general state when it is within [0.7, 0.9] and is out of a better state when it is within [0.9, 1].Therefore, according to the value assignment characteristic and the distribution type of the fault occurrence probability when the equipment is in a better state, the membership degree function is determined as centrally symmetric half mountain distribution, and then the computational formula of the part running state membership degree function is a follows:

$${r}_{{s}_{1}} ( {P}_{i} ) = \{ \begin{matrix}0 , {P}_{i} < 0.4 \\ \frac{1}{2} + \frac{1}{2} sin [ \frac{π}{0.3} ( {P}_{i} - 0.55 ) ] , 0.4 < {P}_{i} \leq 0.7 \\ \frac{1}{2} - \frac{1}{2} sin [ \frac{π}{0.2} ( {P}_{i} - 0.8 ) ] , 0.7 < {P}_{i} \leq 0.9 \\ 0 , {P}_{i} > 0.9\end{matrix}$$

with the fuzzy subset s₄=quasi-fault state, the mechanical equipment is out of a quasi-fault state when the value of the failure mode occurrence probability pᵢ is within [0, 0.7], is in a quasi-fault state or general state when it is within [0.7. 0.9] and is in a quasi-fault state when it is within [0.9, 1]. Therefore, according to the value assignment characteristic and the distribution type of the fault occurrence probability when the equipment is in a better state, the membership degree function is determined as rising half mountain distribution, and then the computational formula of the part running state membership degree function is as follows:

$${r}_{{s}_{1}} ( {P}_{i} ) = \{ \begin{matrix}0 , {P}_{i} < 0.7 \\ \frac{1}{2} + \frac{1}{2} sin [ \frac{π}{0.2} ( {P}_{i} - 0.8 ) ] , 0.7 < {P}_{i} \leq 0.9 \\ 1 , {P}_{i} > 0.9\end{matrix} .$$

S6, fuzzy comprehensive evaluation is applied to the running state of the part: establishing a weight matrix Bₖ=[k1,k2,L,kn] of m failure modes included in the k-th part; acquiring the weight matrix Bₖ and the failure mode occurrence probability membership degree matrix Rₖ of the failure mode affecting the running state of the equipment; calculating the membership degree vector Dₖ=BₖgRₖ=(dₖ(s₁), dₖ(s₂), dₖ(s₃),dₖ(s₄)), attached to the running state of the i-th product; and determining the running state comment of the k-th part according to the maximum membership principle, i.e., the state under the k-th part is located. The above steps are repeated, and the running state membership degree space Cₗ of the l parts included in the mechanical equipment is obtained by calculation:

$${C}_{l} = [ \begin{matrix}{d}_{1} ( {s}_{1} ) & {d}_{1} ( {s}_{2} ) & {d}_{1} ( {s}_{3} ) & {d}_{1} ( {s}_{4} ) \\ {d}_{2} ( {s}_{1} ) & {d}_{2} ( {s}_{2} ) & {d}_{3} ( {s}_{3} ) & {d}_{2} ( {s}_{4} ) \\ L & L & L & L \\ {d}_{l} ( {s}_{1} ) & {d}_{l} ( {s}_{2} ) & {d}_{l} ( {s}_{3} ) & {d}_{l} ( {s}_{4} )\end{matrix} ] .$$

In the step S6, a calculation method for the weight of m failure modes included in the k-th part is as follows:

normalizing the gray relational degrees of m failure modes included in the k-th part, to obtain the weight of each failure mode;

or calculating the weight of each failure mode by adopting an AHP-based weight assignment method.

S7, fuzzy comprehensive evaluation is applied to the running state of the mechanical equipment: defining the weight of the k-th important functional product as ωₖ, such that the weight vector of l important functional product included in the mechanical equipment is Wₜ=(w₁,ω₂,L, ωᵢ): acquiring the state comment S=W_{lg}, Cₗ=(C(s₁),C(s₂),C(s₃),C(s₄)) of the mechanical equipment in combination with the running state membership degree space Cₗ of l parts included in the mechanical equipment, and acquiring the state under which the mechanical equipment is located according to the maximum membership principle.

In the step S7, a calculation method for the weight of l parts is as follows: solving the importance degree of each part, and then carrying out normalization to obtain the weight of each part in the running state evaluation of the mechanical equipment;

or calculating the weight of each part in running state evaluation of the mechanical equipment adopting an AHP-based weight assignment method.

### Embodiment 2

The running state of a power section of a mud pump is evaluated in this embodiment. Taking an F1300 mud pump used in a SZ36-1J work over rig platform as an example the main technical parameters of the mud pump as follows: model: F1300; bore (mm): 180; rated pressure (MPa): P18.7; rated power (KW) 960; impulse (spm): 120; stroke length (mm): 305; displacement (L/s): 46.54. In order to analyze the running state of the mud pump at the power end, the importance degrees and a sequence thereof of parts of the mud pump are determined based on the previously described importance degree evaluation method. The important functional products at the power end are selected: crankshaft, bearing, eccentric gear bearing, connecting rod, large ring gear, pinion shaft, transmission bearing, cross head, upper and lower guide plates and cross head bearing. The important functional products are subject to FMECA analysis to determine the risk level of the failure mode. The features corresponding to all the failure modes of each important functional product are determined according to the characteristics of the products itself, existing inspection means for platform maintenance, failure modes of the product, fault causes, results and other information.

In this embodiment, according to the analysis results of failure modes and features of the important functional parts at the power end, various means such as vibration detection, noise test, temperature detection and qualitative evaluation are selected to carry out real-time feature monitoring on the spindle bearing, the eccentric gear bearing, the crosshead assembly and the like at the power end. In the process of arranging test points, points are arranged as much as possible in combination with the overall structural characteristics of the mud pump, as well as the vibration, noise and temperature coupling relationship between adjacent parts, so as to acquire sufficient and accurate feature measured data.

After a period of continuous data acquisition and evaluation of each failure mode feature, a set of data of a time node is selected for statistics and processing, and the measured data of each feature data are obtained. At the same time, through the field research, related data query and expert evaluation, etc., the rated value, fault-free state value and the allowable range of each feature and the weights having impacts on parts or equipment state are determined, thus calculating the relative degradation degree bᵢ of the feature.

The occurrence probability of the failure modes of each part is evaluated by means of the failure mode occurrence probability evaluation method based on the variable weight synthesis theory. The calculation results are shown in Table 2.

TABLE 2
failure mode Occurrence Probability of Each Part at Power End

| Names of Parts | failure | probability of occurrence |
|---|---|---|
| Spindle bearing (left) | vibration | 0.692 |
| | noise | 0.517 |
| Spindle bearing (right) | vibration | 0.397 |
| | noise | 0.331 |
| Eccentric gear bearing (left) | noise | 0.429 |
| Eccentric gear bearing | noise | 0.405 |
| Eccentric gear bearing (right) | noise | 0.393 |
| Pinion and large gear | noise | 0.374 |
| Pinion bearing | vibration | 0.244 |
| | noise | 0.358 |
| Cross head and upper and | vibration | 0.734 |
| lower guide plates | noise | 0.829 |

The sensitivity of the above-mentioned characteristic parameters to the running state response is considered in the calculation process in combination with the failure mode occurrence probability of each part in Table 2 by adopting a state fuzzy comprehensive evaluation model based on failure mode occurrence probability. The variable weight vector is taken as α=0.3, thereby calculating a state evaluation result of the following parts at the power end, as illustrated in FIG. 3.

TABLE 3
State Evaluation Result of Parts or Assemblies at Power end

| Names of Assem- | State Evaluation | Semantic Description of |
|---|---|---|
| blies and Parts | Result | State Evaluation Results |
| Spindle bearing | (0, 0.370, 0.620, 0) | general state, it is necessary to |
| (left) | | find faults in time |
| Spindle bearing | (0, 0.854, 0.146, 0) | better state, it is necessary to |
| (left) | | intensify monitoring |
| Eccentric gear | (0, 0.977, 0.023, 0) | better state, it is necessary to |
| bearing (left) | | intensify monitoring |
| Eccentric gear | (0, 0.993, 0.007, 0) | better state, it is necessary to |
| bearing (middle) | | intensify monitoring |
| Eccentric gear | (0.003, 0.997, 0, 0) | better state, it can proceed to |
| bearing (right) | | run |
| Pinion and large | (0.041, 0.959, 0, 0) | better state, it can proceed to |
| gear sets | | run |
| pinion bearing | (0.529, 0.471, 0, 0) | good state, it can proceed to |
| | | run |
| cross head and | (0, 0, 0.656, 0.344) | general state, it is necessary to |
| guide plate | | inspect and maintain |
| assembles | | immediately |

The importance degree values of the above-mentioned parts are normalized as weight values in a process of evaluating overall running state of the power end of the mud pump on the basis of the running states of the parts. The running state of the power end of the mud pump can be then evaluated in combination with the state evaluation results of important functional parts or assemblies at the power end in Table 3. The evaluation result is as follows:

S=W_{lg}Cₗ=(C(s₁),C(s₂),C(s₃),C(s₄))=(0.072, 0.723, 0.171, 0.033)

According to the principle of maximum membership degree, the running state of the power end of the mud pump is better, and the monitoring to the power end should be intensified during the running process. At the same time, the running state within the short time can be predicted, and then a reasonable, economical and scientific power-end fault inspection and maintenance program is formulated in combination with the maintenance outline and the production task requirements.

### Embodiment 3

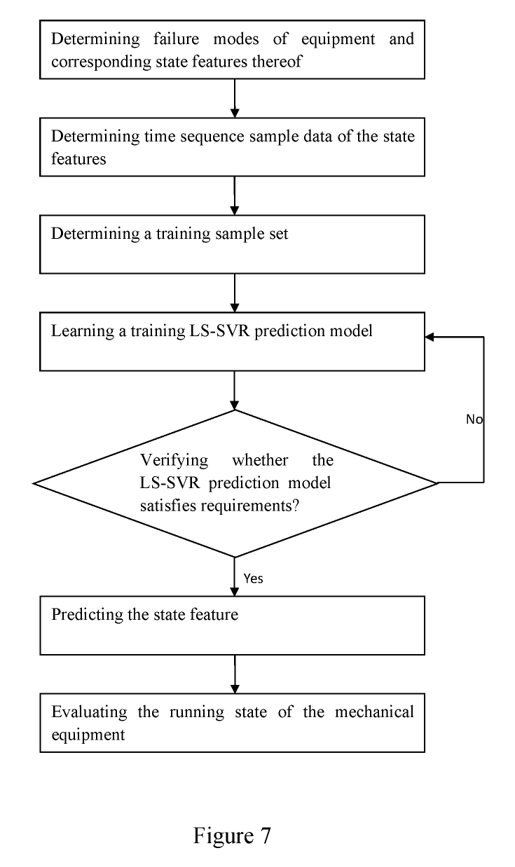

As illustrated in FIG. 7, a mechanical equipment running state fuzzy prediction method with occurrence probability of failure modes comprises the following steps SS1-SS8:

SS1, determining failure modes of equipment and corresponding state features thereof: acquiring failure modes of equipment included in mechanical equipment, and calculating a state feature corresponding to each failure mode.

Preferably, the importance degrees of the parts included in the mechanical equipment are evaluated, wherein the parts of which the important degrees are greater than a set value are taken as important parts. Risk modes of the important parts are obtained by carrying out FMECA analysis on the important parts, and then the risk levels of all the failure modes are calculated. The faults modes of which the risk levels are greater than a set value are taken as high risk failure modes, and then the state feature of each high risk failure mode is extracted. It is set that there are M high risk failure modes in total, with m′ corresponding state features, d₁(t),d₁(t),L,d_{m′}(t), m′=1,2,3,L,respectively.

SS2, determining time sequence sample data of the state features: collecting a plurality of time sequence values of each state feature at regular times, processing the time sequence values of each state feature, and calculating a relative degradation degree of the state feature within a certain time.

The interval of monitoring time is set as τ, τ>0τ(τ>0), and n time sequence values are acquired from any i-th state feature:

dᵢ(0),dᵢ(τ),L,dᵢ(iτ),L,d((n−1)τ)

The time sequence values of the state features are processed to obtain a relative degradation degree, that represents the running state of the equipment, of the state feature within a certain time, as predicted sample data. N sample data of any i-th state feature is as follows:

bᵢ(0),bᵢ(τ),L,bᵢ(iτ),L,bᵢ((n-−1)τ).

SS3, determining a training sample set: establishing the training sample set according to the relative degradation degree of each state feature.

The failure mode of any part is set to include h(0<h<m′) state features. The relative degradation degree of the state feature value is obtained as sample data by front k″ measurements of h state features corresponding to the failure mode at a moment tₙ, that is, the sample data of h state features are as follows:

$$\begin{matrix}{b}_{1} ( ( n - 1 ) τ ) & {b}_{1} ( ( n - 2 ) τ ) & L & {b}_{1} ( ( n - {k}^{″} ) τ ) \\ {b}_{2} ( ( n - 1 ) τ ) & {b}_{2} ( ( n - 2 ) τ ) & L & {b}_{2} ( ( n - {k}^{″} ) τ ) \\ L & L & L & L \\ {b}_{h} ( ( n - 1 ) τ ) & {b}_{h} ( ( n - 2 ) τ ) & L & {b}_{h} ( ( n - {k}^{″} ) τ )\end{matrix}$$

The relative degradation degree bᵢ(nt) of any i-th state feature at a moment nt bᵢ(tₙ)=f[b₁(tₙ₋₁),b₁(Lₙ₋₂),L,b₁(t_{s-k′}), L,b₁(tₙ₋₁), bᵢ(tₙ₋₂),L,bᵢ(r_{n-k″}),L,bₖ(tₙ₋₁), bₖ(tₙ₋₂),L,bₖ(t_{n-k′})] under this failure mode is predicted to be represented as follows:

in which tᵢ is an abbreviation of iτ; f[●] is an input and output mapping relationship. That is, in regression model training, the following training sample pairs are formed: the measured values of input h state features at moments t₁,t₂,L,tₖ correspond to output values of h state features at a moment t_{k′+1}; measured values of input h state features at moments t₂,t₃,L,f_{k′-1} correspond to output values of h state features at a moment f_{k′+2}, and so on.

SS4, learning a training LS-SVR prediction model: with LS-SVM as a predictor, establishing a prediction mode of the state feature using a LS-SVR method;

In order to improve the response correlation between the state features in the same failure mode, different sample data are used for the different state features of different failure modes, that is, the corresponding LS-SVR-based prediction model is established for each state feature. In the prediction model training, the radial basis function is used as a kernel function of LS-SVR. Since this function only needs to determine a kernel parameter σ and can reflect the distance between two data intuitively, a computational formula of the radial basis function is as follows:

K(xᵢ,xᵢ)=exp −|x−xᵤ|²/2σ²

The 10-fold cross validation and grid search method are used to determine the kernel parameter σ.

SS5, verifying the effectiveness of the LS-SVR prediction model: verifying whether the LS-SVR prediction model satisfies requirement, and executing SS6 if the LS-SVR prediction model satisfies requirements.

In this embodiment, the average absolute error ρ and the average relative error δ are used to evaluate the prediction result;

$$ρ = \frac{1}{{m}^{′}} {\sum }_{i = 1}^{m} \vert {b}_{i} ( t ) - {b}_{i}^{*} ( t ) \vert$$

$$δ = \frac{1}{{m}^{′}} {\sum }_{i = 1}^{m} \vert \frac{{b}_{i} ( t ) - {b}_{i}^{*} ( t )}{{b}_{i} ( t )} \vert$$

in which, m′ is a number of features for modeling; b(t) is an actual value of features for modeling; b*(t) is a model calculated value of the features. The greater the average absolute error ρ^{j} is, the greater an offset between the premeasured value and the measured value; the greater the average relative error δ is, the lower the precision of the prediction method. In the actual prediction process, the average absolute prediction error value and the average relative error value can be set as required, thereby judging whether the trained prediction model satisfies requirements.

SS6, predicting the state feature: calculating a prediction value of each state feature according to the LS-SVR prediction model.

After training, LS-SVR nonlinear prediction models of m′ state features are obtained. The first step of any i-th state feature value is predicted, the prediction form is represented as:

bᵢ*(tₙ₋₁)=f[b₁(tₙ₋₁),b₁(tₙ₋₂), L,b₁(t_{n-k′}),L,bᵢ(tₙ₋₁),bⱼ(tₙ₋₂), L,bᵢ(t_{n-k′}),L,bₖ(tₙ₋₁),bₖ(tₙ₋₂), L,bₖ(t_{n-k′})]

The second step thereof is predicted as: bᵢ*(tₙ₊₂)=f(8 b₂(t)ₙ₋₁),b₁(tₙ₋₂),L, b₁(t_{n-k′+}),L,bᵢ(tₙ₋₁),bᵢ(tₙ₋₂),L, bᵢ(t_{n-k′+1}),L,bᵢ(t_{n-k′+1}),L, bₖ(tₙ₋₁),bₖ(tₙ₋₂),L,bₖ(t_{n-k′*1}) and so on, prediction results of multiple steps of the state feature can be formed.

SS7, evaluating the running state of the mechanical equipment according to the prediction value of each state feature. The method of evaluating the running state of the mechanical equipment in this embodiment is the same as that of the first embodiment, that is, the prediction value of m′ features predicted by the j-th step obtained in this embodiment substitutes for the state feature in the first embodiment. And then the running status of the mechanical equipment is evaluated. The resulting evaluation result is the prediction result of the funning state of the mechanical equipment.

Preferably, the prediction method further comprises:

SS8, estimating the remaining life of the mechanical equipment: finishing prediction of one step on the basis of the prediction value of the state feature of the j′-th step, and judging whether the prediction value reaches the state feature threshold thereof; if the value does not reach the state feature threshold thereof, carrying out j′+I-th step prediction of the state feature, and then judging whether the value reaches a set state feature threshold again, till the value in j′+k′-th step prediction reaches the state feature threshold, such that the estimated value of the remaining life of the mechanical equipment is I(j′+k′)τ, wherein τ is a time interval of two adjacent time sequence values of each state feature.

The foregoing descriptions are only preferred embodiments of the present invention. It should be understood that the present invention is not limited to the forms disclosed herein and should not be construed as an exclusion of other embodiments and may be used in various other combinations, modifications and environments. The present invention can be modified within the scope of the present invention as described herein by the techniques or knowledge of the above teachings or related arts. Modifications and changes made by those skilled in the art without departing from the spirit and scope of the present invention should fall within the protection scope of the appended claims.

What is claimed is:

1. A fuzzy evaluation method for running status of a mechanical equipment with occurrence probability of failure modes, comprising:
S1, determining a product set and a failure mode set thereof: l parts included in the mechanical equipment constitute a part set Z, and each of a plurality of failure modes of the l parts are acquired to constitute a failure mode set F of the l parts;
S2, determining a feature set corresponding to each failure mode: calculating a plurality of state features corresponding to m failure modes of a k-th part to constitute a set Yⱼ composed of n state features corresponding to a j-th failure mode of the k-th part, and obtaining a state feature space Y^{m} of m failure modes;
S3, calculation a degradation degree of each feature: calculating a relative degradation degree bᵢ(t) of a i-th state feature in the state feature space Y^{m} at a moment t, i.e., an occurrence probability p(Yⱼ) of the i-th state feature, and calculating a state feature full-degradation probability space p^{m} corresponding to m failure modes;
S4, calculating the occurrence probability of the each failure mode: calculating a comprehensive occurrence probability P(Fⱼ) of the j-th failure mode in the failure mode set F to obtain an occurrence probability set Pⱼ of the m failure modes of the k-th part;
S5, calculating a membership degree of the occurrence probability of the each failure mode: substituting the occurrence probabilities of the m failure modes in a failure mode occurrence probability set Pⱼ into a part running state membership degree function respectively to calculate a membership degree matrix Rₖ of the m failure modes included in the k-th part;
S6, a fuzzy comprehensive evaluation is applied to a running state of each part: establishing a weight matrix Bₖ of the m failure modes included in the k-th part, calculating a membership degree vector Dₖ, attached to the running state, of an i-th product, determining the running state under which the k-th part is located according to a maximum membership principle, and generating a running state membership degree space Cₗ of the l parts included in the mechanical equipment;
S7, the fuzzy comprehensive evaluation is applied to the running state of the mechanical equipment: defining a weight vector of the l parts included in the mechanical equipment as Wᵢ, obtaining a state comment S of the mechanical equipment in combination with the running state membership degree space Cₗ of the l parts included in the mechanical equipment, and obtaining the running state under which the mechanical equipment is located according to the maximum membership principle.

2. The fuzzy evaluation method for running status of the mechanical equipment with occurrence probability of failure modes according to claim 1, wherein the step S1 further comprises:
S11, dividing the mechanical equipment into the l parts which constitute a part set Z={z₁, z₂,L, zₗ};
S12, carrying out a fault risk identification on the each part to obtain each of the plurality of failure modes of the each part, thereby constituting a failure mode set F={F₁, F₂,L,Fₘ} of the each part.

3. The fuzzy evaluation method for running status of the mechanical equipment with occurrence probability of failure modes according to claim 2, wherein, in the step S12, each part is subject to a risk identification by adopting an FMECA method to calculate a plurality of risk equivalence values and a sequence of each of the plurality of failure modes of the each part, and choosing a plurality of key failure modes of the each part to constitute a failure mode set F={F₁, F₂,L, Fₘ} of the each part.

4. The fuzzy evaluation method for running status of the mechanical equipment with occurrence probability of failure modes according to claim 2, wherein, in the step S11, the mechanical equipment is divided into a plurality of parts, an importance degree of the each part is calculated, and the l parts with the importance degree greater than a threshold are chosen from the plurality of parts, the l parts constituting the part set Z={z₁, z₂,L, zₗ}.

5. The fuzzy evaluation method for running status of the mechanical equipment with occurrence probability of failure modes according to claim 4, wherein a method of calculating the importance degree of the each part comprises:
S111, establishing a plurality of importance degree evaluation indexes of an equipment;
S112, establishing a scoring standard of each importance degree evaluation index;
S113, determining, by a plurality of evaluators, an initial weight value and an optimal sequence relationship of the each importance degree evaluation index by adopting an analytic hierarchy process to obtain multiple initial weight values and a plurality of optimal sequence relationships of the each importance degree evaluation index;
S114, processing the multiple initial weight values of the each importance degree evaluation index by adopting a fuzzy Borda sequence value method to obtain a Borda value of the each importance degree evaluation index;
S115, generating a final weight value and an optimal sequence relationship of the each importance degree evaluation index according to the Borda value of the each importance degree evaluation index;
S116, calculating the importance degree of the equipment according to the final weight value and the optimal sequence relationship of the each importance degree evaluation index.

6. The fuzzy evaluation method for running status of the mechanical equipment with occurrence probability of failure modes according to claim 1, wherein, in the step S3, a computational formula of the fault occurrence probability p(Yⱼ) is as follows:
p(Yⱼ)=bᵢ(t)=F[Yᵢ(t), Yᵢ₀, Yᵢ*]
in the formula, j=1,2,L, n; F[●] is a relative degradation degree function of the i-th state feature; Yᵢ(t) is a state value of the i-th state feature at the moment t:Yᵢ₀ is a normal value of the i-th state feature: Yᵢ* is a threshold of fault or shutdown caused by the i-th state feature.

7. The fuzzy evaluation method for running status of the mechanical equipment with occurrence probability of failure modes according to claim 1 wherein, in the step S4, a computational formula of the comprehensive occurrence probability P(Fⱼ) of the j-th failure mode in the failure mode feature set F is as follows:
$$P ( {F}_{j} ) = [ p ( {Y}_{i} ) , p ( {Y}_{2} ) , L , p ( {Y}_{n} ) ] [ \begin{matrix}{ω}_{1} \\ {ω}_{2} \\ L \\ {ω}_{n}\end{matrix} ] ;$$
in the formula: n is the number of plurality of state features corresponding to the j-th failure mode in the failure mode set F: ω=[ω₁,ω₂,L, ωₙ]^{τ} is a weight vector corresponding to a state feature set, wherein ωᵢ∈[0,1] and satisfies
$${\sum }_{i = 1}^{n} {ω}_{i} = 1.$$

8. The fuzzy evaluation method for running status of the mechanical equipment with occurrence probability of failure modes according to claim 1, wherein, in the step S5, the running state of the each part is divided into four running states, namely, a good state, a better state, a general state and a quasi-fault state, the four running states being considered as four fuzzy subsets S={s₁,s₂,s₃,s₄} by applying a fuzzy set theory;
with a fuzzy subset s₁=good state, the part is in the good state when a value of a failure mode occurrence probability pᵢ is within [0, 0.2], the part is in the good state or the better state when the value of the failure mode occurrence probability pᵢ is within [0.2, 0.4], and the part is out of the good state when the value of the failure mode occurrence probability ᵢ is within [0.4, 1], and then a computational formula of the part running state membership degree function of the part is as follows:
$${r}_{{s}_{1}} ( {P}_{i} ) = \{ \begin{matrix}1 , {P}_{i} < 0.2 \\ \frac{1}{2} - \frac{1}{2} sin [ \frac{π}{0.2} ( {P}_{i} - 0.3 ) ] , 0.2 < {P}_{i} \leq 0.4 \\ 0 , {P}_{i} > 0.4\end{matrix}$$
with the fuzzy subset s₂=better state, the part is out of the better state when the value of the failure mode occurrence probability pᵢ is within [0, 0.2], the part is in a good state or better state when the value of the failure mode occurrence probability pⱼ is within [0.2, 0.4], the part is in the better state or the general state when the value of the failure mode occurrence probability pᵢ is within [0.4, 0.7] and the part is out of a better state when the value of the failure mode occurrence probability pᵢ is within [0.7, 1], and then the computational formula of the part running state membership degree function of the part is as follows:
$${r}_{{s}_{1}} ( {P}_{i} ) = \{ \begin{matrix}0 , {P}_{i} < 0.2 \\ \frac{1}{2} + \frac{1}{2} sin [ \frac{π}{0.2} ( {P}_{i} - 0.3 ) ] , 0.2 < {P}_{i} \leq 0.4 \\ \frac{1}{2} - \frac{1}{2} sin [ \frac{π}{0.3} ( {P}_{i} - 0.55 ) ] , 0.4 < {P}_{i} \leq 0.7 \\ 0 , {P}_{i} > 0.7\end{matrix} ;$$
with the fuzzy subset s₃=general state, the part is out of the general state when the value of the failure mode occurrence probability pᵢ is within [0, 0.4], the part is in the good state or the better state when the value of the failure mode occurrence probability pᵢ is within [0.4, 0.7], the part is in a quasi-fault state or the general state when the value of the failure mode occurrence probability pᵢ is within [0.7, 0.9] and the part is out of the general state when the value of the failure mode occurrence probability pᵢ is within [0.9, 1], and then the computational formula of the part running state membership degree function of the part is as follows:
$${r}_{{s}_{1}} ( {P}_{i} ) = \{ \begin{matrix}0 , {P}_{i} < 0.4 \\ \frac{1}{2} + \frac{1}{2} sin [ \frac{π}{0.3} ( {P}_{i} - 0.55 ) ] , 0.4 < {P}_{i} \leq 0.7 \\ \frac{1}{2} - \frac{1}{2} sin [ \frac{π}{0.2} ( {P}_{i} - 0.8 ) ] , 0.7 < {P}_{i} \leq 0.9 \\ 0 , {P}_{i} > 0.9\end{matrix} ;$$
with respect to the fuzzy subset s₄=quasi-fault state, the part is out of the quasi-fault state when the value of the failure mode occurrence probability p₁ is within [0, 0.7], the part is in the quasi-fault state or the general state when the value of the failure mode occurrence probability pⱼ is within [0.7, 0.9], and the part is in the quasi-fault state when the value of the failure mode occurrence probability p, is within [0.9, 1], and then the computational formula of the part running state membership degree function of the part is as follows:
$${r}_{{s}_{1}} ( {P}_{i} ) = \{ \begin{matrix}0 , {P}_{i} < 0.7 \\ \frac{1}{2} + \frac{1}{2} sin [ \frac{π}{0.2} ( {P}_{i} - 0.8 ) ] , 0.7 < {P}_{i} \leq 0.9 \\ 1 , {P}_{i} > 0.9\end{matrix} .$$

9. A mechanical equipment running state fuzzy prediction method with occurrence probability of failure modes, comprising:
SS1, a plurality of failure modes of an equipment and a plurality of corresponding state features thereof: acquiring the plurality of failure modes of the equipment included in the mechanical equipment, and calculating a state feature corresponding to each failure mode;
SS2, determining time sequence sample data of the the plurality of state features: collecting a plurality of time sequence values of each state feature at regular times, processing the plurality of time sequence values of the each state feature, and calculating a relative degradation degree of the each state feature within a predetermined time;
SS3, determining a training sample set: establishing the training sample set according to the relative degradation degree of the each state feature;
SS4, learning a training LS-SVR prediction model: with LS-SVM as a predictor, establishing a prediction model of the each state feature using a LS-SVR method;
SS5, verifying an effectiveness of the LS-SVR prediction model: verifying whether the LS-SVR prediction model satisfies a plurality of requirements, and executing SS6 if the LS-SVR prediction model satisfies the plurality of requirements;
SS6, predicting the each state feature: calculating a prediction value of the each state feature according to the LS-SVR prediction model; and
SS7, evaluating a running state of the mechanical equipment according to the prediction value of the each state feature.

10. The mechanical equipment running state fuzzy prediction method with occurrence probability of failure modes according to claim 9, further comprising:
SS8, estimating a remaining life of the mechanical equipment: finishing a prediction of one step on the basis of the prediction value of the each state feature of a j′-th step, and judging whether the prediction value achieves a state feature threshold thereof; if the prediction value does not reach the state feature threshold thereof, carrying out a state feature prediction of a j′+l-th step, and then judging whether the prediction value reaches a predetermined state feature threshold again, till the prediction value of a j′+k′-th step reaches the state feature threshold thereof, wherein an estimated value of the remaining life of the mechanical equipment is □ (j′+k′)τ, in which τ is a time interval of two adjacent time sequence values of the each state feature.
